(19) United States
(12) Patent Application Publication
(10) Pub. No.: US 2015/0367650 A1
(43) Pub. Date: Dec. 24, 2015

(54) Print Head Cleaning Apparatus And Method For A Ribbon Printing System

(71) Applicant: ILLINOIS TOOL WORKS INC., Glenview, IL (US)

(72) Inventor: Matt Breckheimer, Downers Grove, IL (US)

(73) Assignee: ILLINOIS TOOL WORKS INC., Glenview, IL (US)

(21) Appl. No.: 14/765,254

(22) PCT Filed: Jan. 24, 2014
(86) PCT No.: PCT/US2014/012935

§ 371 Date: Jul. 31, 2015

Related U.S. Application Data
(63) Continuation of application No. 13/757,234, filed on Feb. 1, 2013, now abandoned.

(51) Int. Cl. B41J 2/325

(52) U.S. Cl. CPC B41J 2/325

(57) ABSTRACT

A cleaning apparatus for a ribbon printing system includes a base support and an insert. The base support has a receiving area configured to receive a cleaning pad and the insert is configured to secure the cleaning pad in the receiving area or the base support. The base support is shaped to fit between a printer and a backup platen of the ribbon printing system when the insert secures the cleaning pad in the base support so that a thermal print head of the printer engages the cleaning pad in order to clean the print head.

### CROSS-REFERENCE TO RELATED APPLICATIONS

This application claims priority to and is a national stage entry of PCT International Application Number PCT/US2014/012935, which was filed on 24 Jan. 2014, and which claims priority to U.S. patent application Ser. No. 13/757.234. filed 1 Feb. 2013, the entire disclosures of which are incorporated herein by reference.

### BACKGROUND

A variety of printing systems can apply or print images (e.g., graphics, text, or the like) on exterior surfaces of objects. Many of these systems directly engage or contact the exterior surfaces on which the images are printed. For example, a thermal transfer printing process can involve a print ribbon having ink that is transferred onto a target object by applying heat and pressure to the print ribbon as the print ribbon engages the target object. The print ribbon may be provided from an unwind spindle or reel, where the print ribbon extends through one or more rollers to cause the ribbon to be disposed between a thermal print head and the target object. From this location, the print ribbon may extend through one or more rollers to a windup spindle or reel.

The thermal print head applies the heat and pressure to the ribbon in order to transfer ink in the ribbon to the target object. Over time, substances from the ribbon can build up on the print head and negatively impact printing and/or reduce the useful life of the print head. For example, wax, ink, and other substances from the ribbon can build up on the print head and inhibit the ability of the print head to apply an even pressure and heat to the ribbon. The build up can act as a thermal barrier that negatively impacts the transfer of ink from the ribbon to the target object, such as by producing blurry printed lines. Some operators attempt to remedy this by increasing power supplied to the print head to increase the heat applied to the ribbon. But, this increased power can reduce the life of the print head.

### BRIEF SUMMARY

In one embodiment, a cleaning apparatus for a ribbon printing system includes a base support and an insert. The base support has a receiving area configured to receive a cleaning pad and the insert is configured to secure the cleaning pad in the receiving area of the base support. The base support is shaped to fit between a printer and a backup platen of the ribbon printing system when the insert secures the cleaning pad in the base support so that a thermal print head of the printer engages the cleaning pad in order to clean the print head.

In one embodiment, a method includes printing on one or more target objects using a thermal printing system when the one or more target objects are positioned between a printer and a backup platen of the thermal printing system. The one or more target objects are printed upon by a print head applying heat and pressure to a ribbon in the printer to transfer ink from the ribbon to the one or more target objects. The method also includes determining whether lo clean the print head of the thermal printing system, removing the one or more target objects from between the printer and the backup platen, removing the ribbon from between the print head and the backup platen, inserting a cleaning pad between the printer and the backup platen, and cleaning the print head by moving the print head to engage and laterally move across the cleaning head.

### BRIEF DESCRIPTION OF THE DRAWINGS

Reference is now made briefly to the accompanying drawings, in which:

FIG. 1 is a schematic view of one embodiment of a printing system;

FIG. 2 is a side view of the printing system shown in FIG. 1;

FIG. 3 is a partial cut-away view of the priming system as shown in FIG. 2;

FIG. 4 is an exploded view of one embodiment of the print head cleaning apparatus;

FIG. 5 is a view of another embodiment of a print head cleaning apparatus;

FIG. 6 illustrates one embodiment of insertion of a cleaning pad in the apparatus shown in FIG. 4;

FIG. 7 illustrates one embodiment of insertion of the apparatus shown in FIG. 4 with the cleaning pad into a cleaning position for cleaning the print head;

FIG. 8 illustrates a schematic diagram of the cleaning of the print head against the cleaning pad in the apparatus; and

FIG. 9 is a flowchart of an embodiment of a method for cleaning a print head of a printing system.

### DETAILED DESCRIPTION

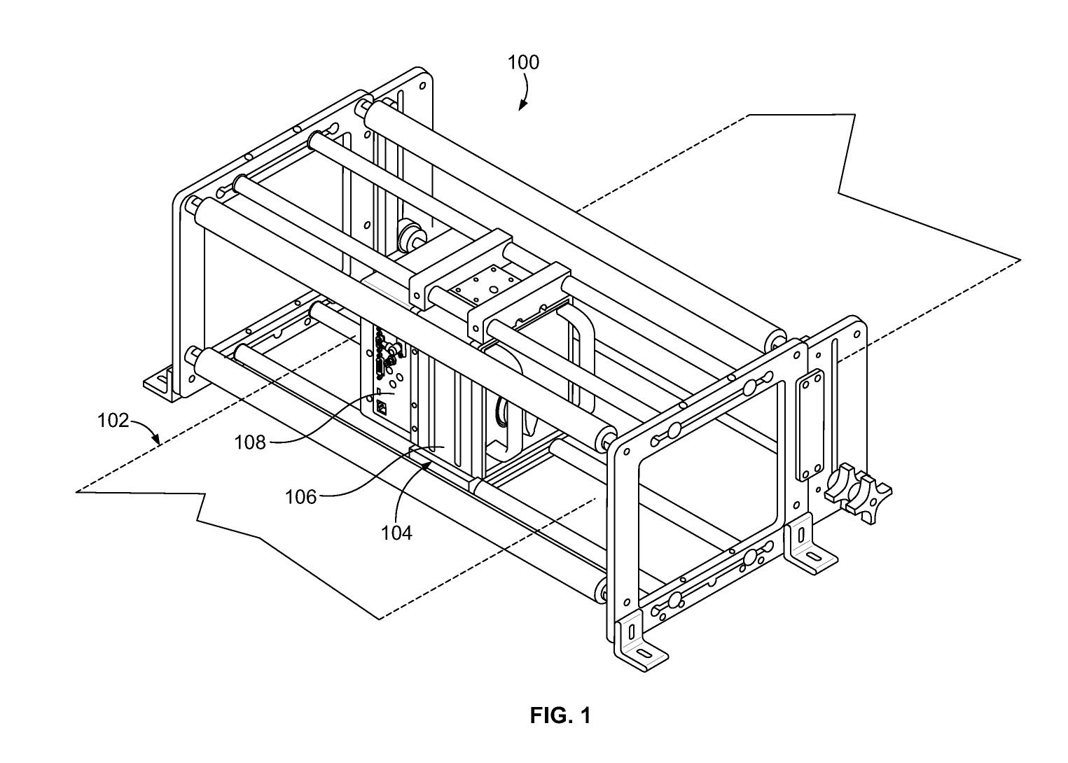

FIG. 1 is a schematic view of one embodiment of a priming system 100. The printing system 100 may be a thermal printing system that prints images on exterior surfaces of target objects 102 by applying heat and pressure to a print ribbon that includes ink. In the illustrated embodiment, the target object 102 is a relatively wide planar sheet, but alternatively may be in another shape. The heat and pressure transfers the ink from the print ribbon onto the target object 102.

The printing system 100 includes a printer 106 having an unwind spindle with ribbon provided thereon, a windup spindle that is connected with the ribbon and that rotates to pull the ribbon from the unwind spindle, and one or more rollers around which the ribbon at least partially wraps. The ribbon is directed by the rollers to a location along the bottom of the printer 106 that is relatively close to the target object 102. As the ribbon passes by this location, a thermal print head applies heat and pressure to the ribbon to transfer ink from the ribbon onto the target object 102. The ribbon continues to be pulled by the windup spindle, where the used ribbon is collected.

In order to allow the print head to apply pressure to the ribbon, a backup platen 104 is provided. The backup platen 104 is relatively rigid, substantially flat body that provides support for the target object 102 as the print head applies heat and pressure to the ribbon. The backup platen 104 may include a rubberized (e.g., silicone) surface that is spaced a relatively small distance away from the print head. During printing, the target object 102 is located between the backup platen 104 and the ribbon, and the ribbon is located between the target object 102 and the print head. The print head presses the ribbon against the target object 102. which is pressed against the backup platen 104.

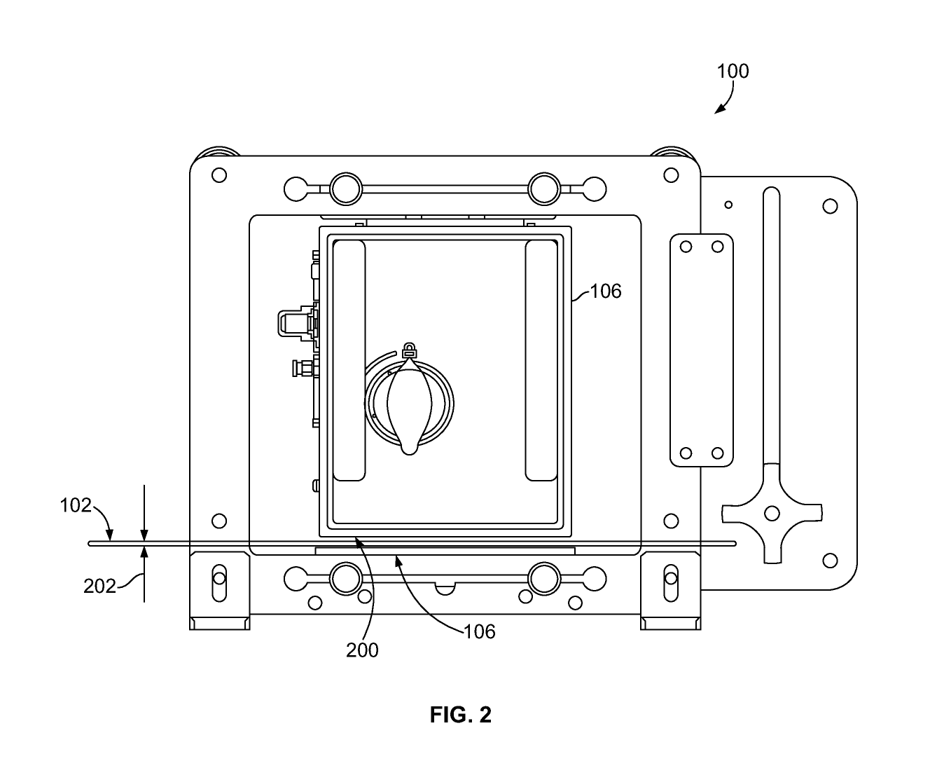

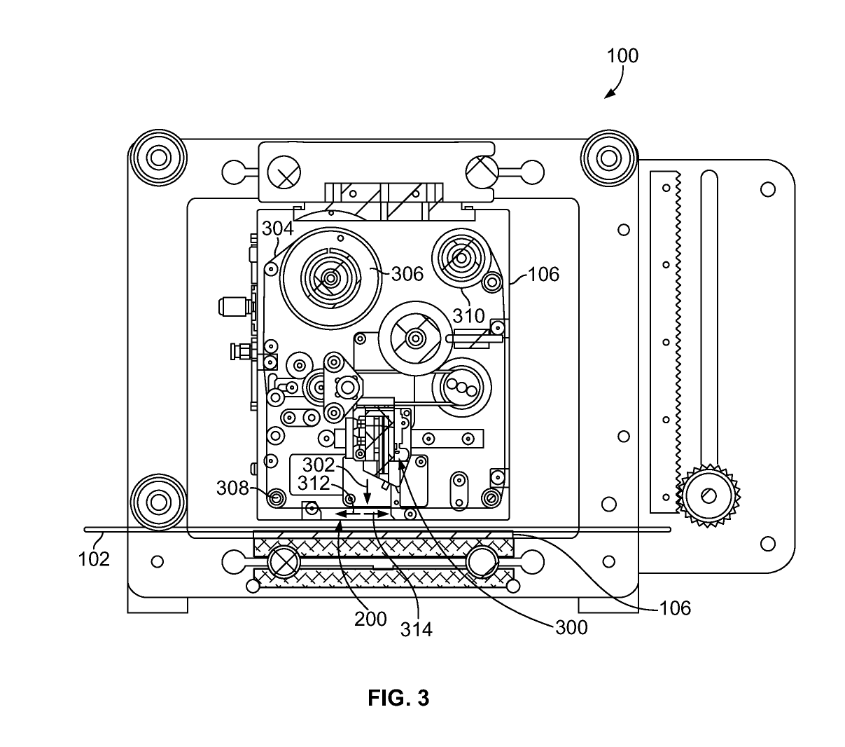

FIG. 2 is a side view of the printing system 100 shown in FIG. 1. FIG. 3 is a partial cut-away view of the printing system 100 as shown in FIG. 2. A print ribbon 304 extends from an unwind spindle 306, across one or more rollers 308, between the print head 300 and the backup platen 106, and is collected on a windup spindle 310. A bottom side 200 of the printer 106 represents where the print head 300 of the printer 106 engages the print ribbon to press the ribbon against the target object 102. During printing, the print head 300 lowers along an engagement direction 302 to press the ribbon against the target object 102 and then moves laterally relative to the ribbon along one or more directions 312, 314 to apply the ink in the ribbon to the target object 102. The print head 300 may then recess along a direction that is oriented opposite of the engagement direction 302 when printing on the target object 102 is complete.

As shown in FIG. 2, there is relatively little space 202 between the bottom side 200 of the printer 106 and the backup platen 104. Consequently, it can be difficult to clean the print head 300 inside the printer 106 without at least partially disassembling the printing system 100 and the printer 106. Such disassembly can involve significant downtime from printing operations.

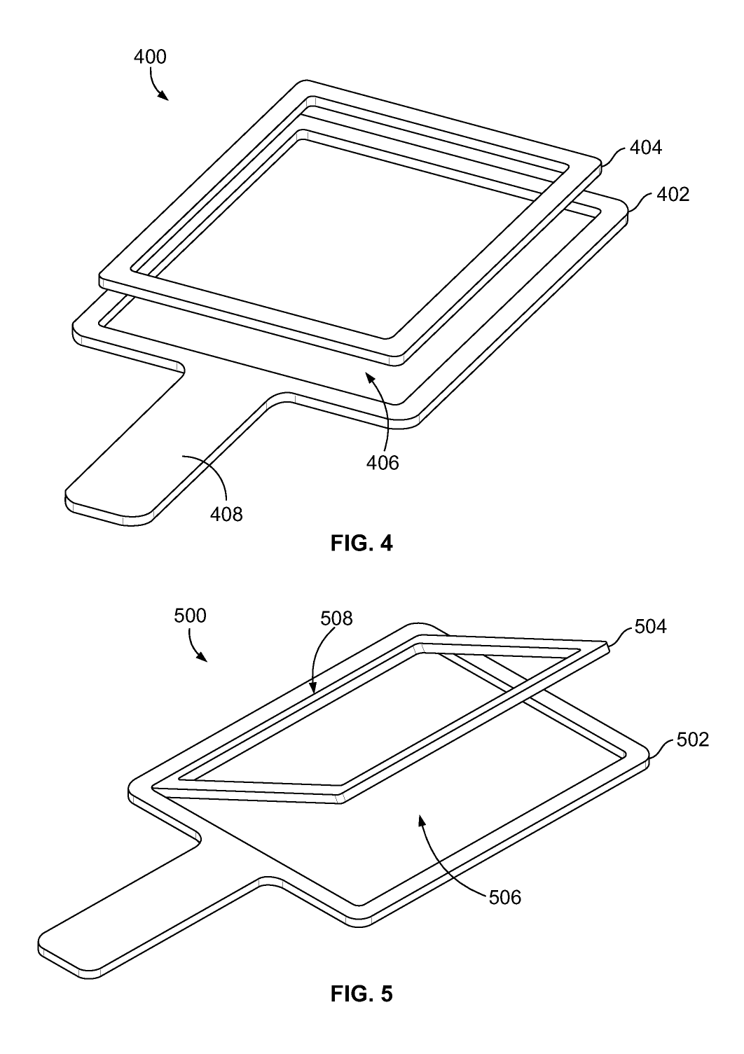

In accordance with one embodiment, a print head cleaning apparatus is used to clean the print head 300 of the printer 106 without disassembling the primer 106 and/or the printing system 100. FIG. 4 is an exploded view of one embodiment of the print head cleaning apparatus 400. The apparatus 400 includes a base support 402 and an insert 404 that fits within the base support 402. The base support 402 defines a receiving area 406 in which a cleaning pad may be inserted. For example, the base support 402 may define a frame around an open area in which the cleaning pad may be placed. Alternatively, the receiving area 406 may be a recessed section of the base support 402 instead of an opening through the base support 402. The insert 404 is sized to fit within the receiving area 406 to secure the cleaning pad between the insert 404 and the base support 402. For example, the insert 404 may be sufficiently large to engage an inner surface of the base support 402 within the receiving area 406 to create a press-fit connection. Additionally or alternatively, the insert 404 and base support 402 may have complementary engagement features that serve to lock or secure the insert 404 and the base support 402 together. The base support 402 shown in FIG. 4 includes an elongated, protruding handle 408 that can be grasped by an operator of the printing system 100 for insertion of the apparatus 400 into the printing system 100 and removal of the apparatus 400 from the printing system 100 for cleaning the print head 300.

FIG. 5 is a view of another embodiment of a print head cleaning apparatus 500. Similar to the apparatus 400 shown in FIG. 4, the apparatus 500 includes a base support 502 and an insert 504. The base support 502 defines a receiving area 506 in which the cleaning pad may be received, and the insert 504 secures the cleaning pad in the receiving area 506. One difference between the apparatus 500 and the apparatus 400 is that the insert 504 is connected to the base support 502, such as by a hinge or hinged connection 508, whereas the insert 404 is separate from the base support 402.

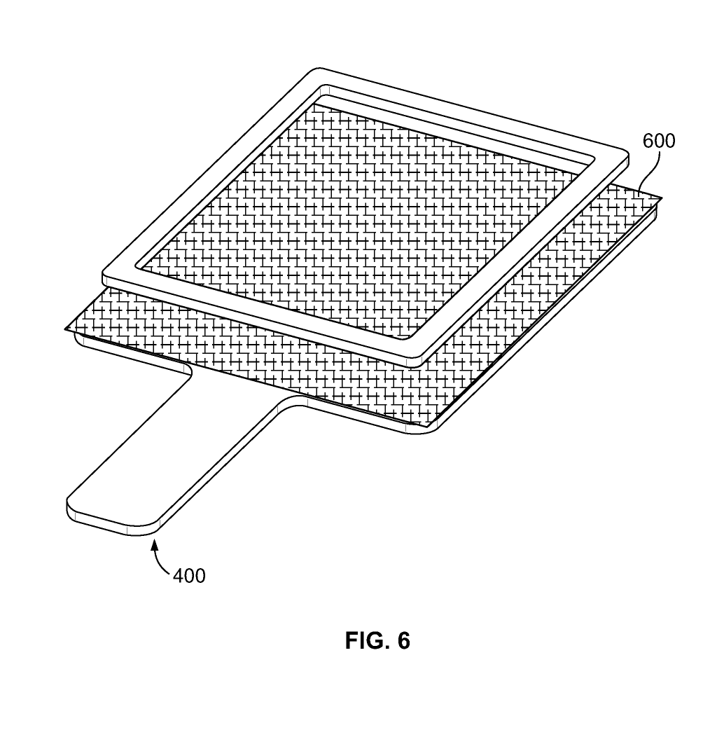

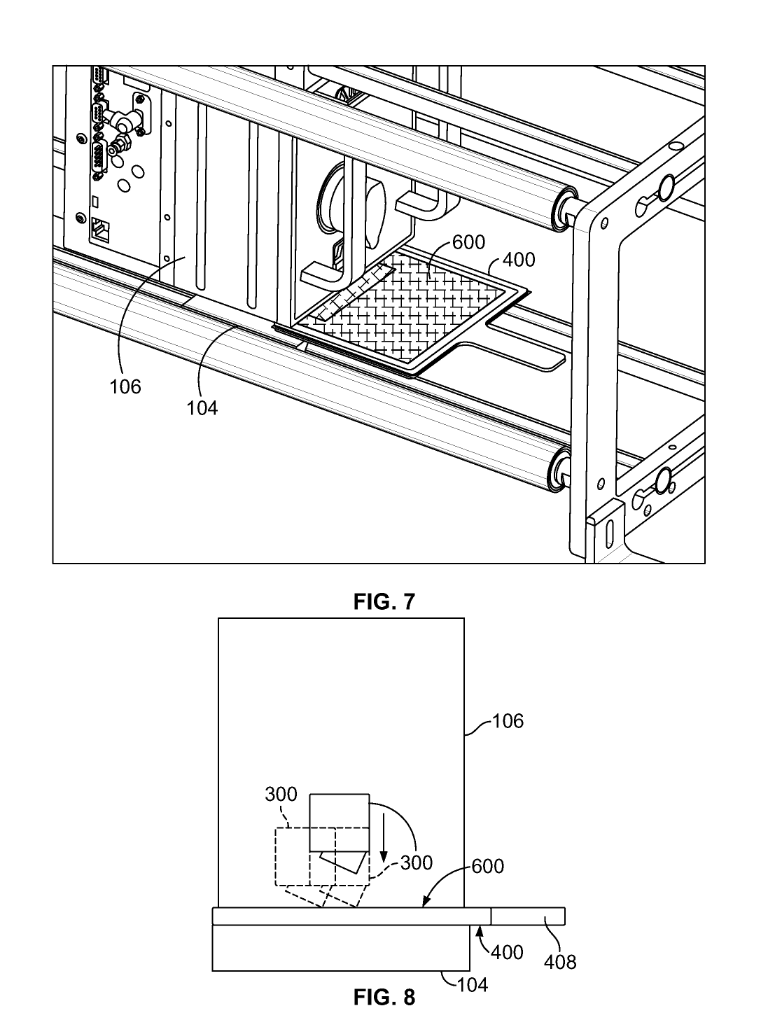

FIG. 6 illustrates one embodiment of insertion of a cleaning pad 600 in the apparatus 400. With the insert 404 removed from the receiving area 406 of the base support 402, the cleaning pad 600 is positioned in or above the receiving area 406. The insert 404 may then be positioned inside the receiving area 406 to secure the cleaning pad 600 in the apparatus 400 (as shown in FIG. 7). The cleaning pad 600 may be an abrasive flexible sheet that removes the buildup of substances on the print head 300 when the print head 300 engages and moves across the cleaning pad 600. For example, the cleaning pad 600 may have a rough surface that removes wax buildup on the print head 300 from the ribbon in the printer 106 when the print head 300 engages and moves across the cleaning pad 600. The cleaning pad 600 may include or be saturated with one or more liquid compounds, such as chemical compounds that assist in cleaning the print head 300.

Returning to the discussion of the printing system 100 shown in FIG. 1, the printing system 100 may include or be coupled with a controller 108 that controls operations of the printing system 100, such as how fast the ribbon is pulled through the printer 104 by the windup spindle, the temperature of the print head 300, the pressure applied by the print head 300 on the ribbon, the speed at which the print head 300 moves along the ribbon, and the like. This controller 108 also may track how long it has been since the print head 300 was last cleaned. The controller 108 may use a timer that begins after the print head 300 is cleaned and continues until the print head 300 is cleaned and/or the timer expires. Additionally or alternatively, the controller 108 may track how many times the print head 300 is used to print ink from the ribbon onto one or more target objects since the last time the print head 300 was cleaned. When the timer expires and/or the number of times the print head 300 is used reaches a designated threshold, the controller 108 may notify an operator of the printing system 100. For example, the controller 108 may include or be connected with a display device, light, speaker, or other audible and/or visual notification device that generates a sound, light, display, or the like, to notify the operator when to clean the print head 300. Additionally or alternatively, the operator may clean the print head 300 when the ribbon on an unwind spindle has been consumed and there is no more additional ribbon from which to print.

In order to clean the print head 300, the ribbon may need lo be moved from between the print head 300 and the backup platen 104. The ribbon can be removed from the printer 106 so that the print head 300 will not engage any ribbon when the print head 300 moves in the engagement direction 302 (shown in FIG. 3).

FIG. 7 illustrates one embodiment of insertion of the apparatus 400 with the cleaning pad 600 into a cleaning position for cleaning the print head 300. When the print head 300 is to be cleaned, the target object 102 is removed from between the backup platen 104 and the printer 106. The cleaning pad 600 is placed into the apparatus 400 and secured with the insert 404, and then positioned between the printer 106 and the backup platen 104. The printer 106 may then be activated so that the print head 300 acts in a similar manner as when the print head 300 applies heal and pressure to the ribbon to print on a target object, but to clean the print head 300 against the cleaning pad 600 of the apparatus 400.

FIG. 8 illustrates a schematic diagram of the cleaning of the print head 300 against the cleaning pad 600 in the apparatus 400. The apparatus 400 with the cleaning pad 600 may be positioned between the printer 106 and the backup platen 104 in a similar position as the target object 102 shown in FIG. 1. The printer 106 may then be activated so that the print head 300 moves toward and engages the cleaning pad 600 being held by the apparatus 400, just as the print head 300 would do to engage the ribbon being used lo print on the target object. The print head 300 may then laterally move across the cleaning pad 600 to wipe off build up on the print head 300 onto the cleaning pad 600. This lateral movement may be the same movement that the print head 300 performs when printing from the ribbon. The print head 300 may then return to the initial or beginning position separated from the cleaning pad 600. The print head 300 may cycle through several iterations of lowering to engage the cleaning pad 600, moving across the cleaning pad 600 to remove build up from the print head 300, and removal of the print head 300 from the cleaning pad 600.

In one embodiment, the surface area of the cleaning pad 600 that is exposed in the apparatus 400 may be several times larger than the surface area over which the print head 300 swipes when the print head 300 laterally moves across the cleaning pad 600. The larger cleaning pad 600 may be moved relative to the printer 106 between iterations of the cleaning the print head 300 so that different sections of the cleaning pad 600 are used to clean the print head 300 in the different iterations.

When cleaning of the print head 300 is complete, the apparatus 400 may be removed from between the printer 106 and the backup platen 104. The cleaning pad 600 may be removed from the apparatus 400, or can be left in the apparatus 400 to be used for a later cleaning operation. When the cleaning pad 600 is to be replaced, the insert 404 of the apparatus 400 can be removed, the cleaning pad 600 lifted out of the receiving area 406 of the apparatus 400, and discarded. Another cleaning pad 600 may be used for the next cleaning operation using the apparatus 400.

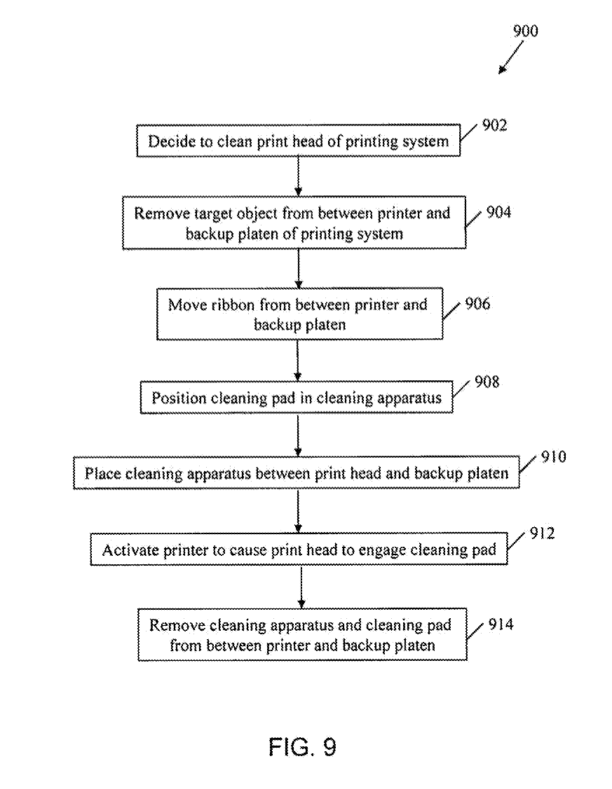

FIG. 9 is a flowchart of an embodiment of a method 900 for cleaning a print head of a printing system. The method 900 may be used in conjunction with the printing system 100 and the print head cleaning apparatus 400 described above. At 902, a decision is made to clean the print head 300 of the printing system 100. This decision may be performed manually, such as by an operator deciding when to clean the print head 300 based on manual inspection of previous prints on the target object 102. a previously designated cleaning schedule, a change in work shifts, or the like. The decision may be automatically performed, such as by notifying the operator when to clean the print head 300 based on expiration of a timer and/or a number of printing operations that have been performed since last cleaning the print head 300 meeting a designated threshold.

At 904, the target object 102 is removed from between the backup platen 104 and the bottom side 200 of the printer 106. At 906, the ribbon is moved from between the print head 300 and the backup platen 104. In one embodiment, the ribbon may be removed by pulling the ribbon off of the unwind spindle and past the location between the print head 300 and the backup platen 104. Alternatively, an operator may remove the unwind and/or windup spindles, along with the ribbon, from the printer 106.

At 908, the cleaning pad 600 is positioned in the cleaning apparatus 400. For example, the cleaning apparatus 400 may be opened to receive the cleaning pad 600. The insert 404 may be removed or moved from the receiving area 406 of the base support 402. The cleaning pad 600 may then be positioned in the receiving area 406 and the insert placed therein to secure the cleaning pad 600 in the apparatus 400.

At 910, the apparatus 400 is positioned between the bottom side 200 of the printer 106 and the backup platen 104. The apparatus 400 may be oriented so that the cleaning pad 600 faces the print head 300. At 912, the printer 106 is activated to cause the print head 300 to engage and move across the cleaning pad 600. As described above, the print head 300 may move in a manner that is similar to when the print head 300 moves to print ink from the ribbon onto a target object. Buildup of substances on the print head 300 can be removed by contact between the print head 300 and the cleaning pad 600, as well as by the movement of the print head 300 across the cleaning pad 600. The print head 300 may engage and move across the cleaning pad 600 once, or can repeat these actions multiple times.

At 914, the cleaning apparatus 400 and cleaning pad 600 are removed from between the printer 106 and the backup platen 104. A ribbon may be positioned or re-positioned in the printer 106 so that the cleaned print head 300 can return to printing on target objects.

In one embodiment, a cleaning apparatus for a ribbon printing system includes a base support and an insert. The base support has a receiving area configured to receive a cleaning pad and the insert is configured to secure the cleaning pad in the receiving area of the base support. The base support is shaped to fit between a printer and a backup platen of the ribbon printing system when the insert secures the cleaning pad in the base support so that a thermal print head of the printer engages the cleaning pad in order to clean the print head.

In one aspect, the base support is shaped to fit in a space between the printer and the backup platen that is where a target object that is printed upon by the thermal print head is located.

In one aspect, the insert is configured to allow removal of the cleaning pad for replacement with another cleaning pad.

In one aspect, the base support and the insert are configured to hold the cleaning pad while the print head engages and moves across the cleaning pad in directions that the print head moves during printing on a target object from a ribbon in the printer.

In one aspect, the insert is separate from the base support.

In one aspect, the insert is connected with the base support by a hinged connection.

In one embodiment, a method includes printing on one or more target objects using a thermal printing system when the one or more target objects are positioned between a printer and a backup platen of the thermal printing system. The one or more target objects are printed upon by a print head applying heat and pressure to a ribbon in the printer to transfer ink from the ribbon to the one or more target objects. The method also includes determining whether to clean the print head of the thermal printing system, removing the one or more target objects from between the printer and the backup platen, removing the ribbon from between the print head and the backup platen, inserting a cleaning pad between the printer and the backup platen, and cleaning the print head by moving the print head to engage and laterally move across the cleaning head.

In one aspect, determining whether to clean the print head includes determining if an elapsed time since a previous cleaning of the print head has been met.

In one aspect, determining whether to clean the print head includes determining if a number of the one or more target objects that have been printed upon since a previous cleaning of the print head is at least a designated threshold.

In one aspect, the method also includes loading the cleaning pad into a cleaning apparatus having a base support and an insert sized to secure the cleaning pad in a receiving area of the base support. Inserting the cleaning pad includes positioning the cleaning apparatus and the cleaning pad between the printer and the backup platen.

In one aspect, cleaning the print head includes activating the printer to print without the ribbon such that the print head engages and moves across the cleaning pad in movements similar to the print head engaging and moving across the ribbon to print onto the one or more target objects.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function formal and are not intended lo be interpreted based on 35 U.S.C. §112(f), unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A cleaning apparatus for a ribbon printing system, the apparatus comprising:
a base support having a receiving area configured to receive a cleaning pad; and
an insert configured to secure the cleaning pad in the receiving area of the base support, wherein the base support is shaped to fit between a printer and a backup platen of the ribbon printing system when the insert secures the cleaning pad in the base support so that a thermal print head of the printer engages the cleaning pad in order to clean the print head.

2. The cleaning apparatus of claim 1, wherein the base support is shaped to fit in a space between the printer and the backup platen that is where a target object that is printed upon by the thermal print head is located.

3. The cleaning apparatus of claim 1, wherein the insert is configured to allow removal of the cleaning pad for replacement with another cleaning pad.

4. The cleaning apparatus of claim 1, wherein the base support and the insert are configured to hold the cleaning pad while the print head engages and moves across the cleaning pad in directions that the print head moves during printing on a target object from a ribbon in the printer.

5. The cleaning apparatus of claim 1, wherein the insert is separate from the base support.

6. The cleaning apparatus of claim 1, wherein the insert is connected with the base support by a hinged connection.

7. A method comprising:
printing on one or more target objects using a thermal printing system when the one or more target objects are positioned between a printer and a backup platen of the thermal printing system, the one or more target objects printed upon by a print head applying heat and pressure to a ribbon in the printer to transfer ink from the ribbon to the one or more target objects;
determining whether to clean the print head of the thermal printing system;
removing the one or more target objects from between the printer and the backup platen;
removing the ribbon from between the print head and the backup platen;
inserting a cleaning pad between the printer and the backup platen; and
cleaning the print head by moving the print head to engage and laterally move across the cleaning head.

8. The method of claim 1, wherein determining whether to clean the print head includes determining if an elapsed time since a previous cleaning of the print head has been met.

9. The method of claim 1, wherein determining whether to clean the print head includes determining if a number of the one or more target objects that have been printed upon since a previous cleaning of the print head is at least a designated threshold.

10. The method of claim 1, further comprising loading the cleaning pad into a cleaning apparatus having a base support and an insert sized to secure the cleaning pad in a receiving area of the base support, wherein inserting the cleaning pad includes positioning the cleaning apparatus and the cleaning pad between the printer and the backup platen.

11. The method of claim 1, wherein cleaning the print head includes activating the printer to print without the ribbon such that the print head engages and moves across the cleaning pad in movements similar to the print head engaging and moving across the ribbon to print onto the one or more target objects.
